(19) United States
(12) Patent Application Publication
(10) Pub. No.: US 2026/0034593 A1
(43) Pub. Date: Feb. 5, 2026

(54) WORK MACHINE

(71) Applicant: Koki Holdings Co., Ltd., Tokyo (JP)

(72) Inventors: Keigo ISEDA, Ibaraki (JP); Ken INUI, Ibaraki (JP)

(73) Assignee: Koki Holdings Co., Ltd., Tokyo (JP)

(21) Appl. No.: 18/995,810

(22) PCT Filed: May 26, 2023
(86) PCT No.: PCT/JP2023/019615

§ 371 Date: Jan. 16, 2025

(30) Foreign Application Priority Data
Jul. 29, 2022 (JP) 2022-121259

(51) Int. Cl. B23D 49/16; B25F 5/00

(52) U.S. Cl. CPC B23D 49/16; B25F 5/001

(57) ABSTRACT

A work machine includes: a motor; a plunger that is reciprocated in the front-back direction by the drive of the motor; a transmission mechanism that converts a rotational driving force of the motor into a reciprocating driving force and transmits the reciprocating driving force to the plunger; a first support that supports the plunger to be capable of reciprocating and is disposed on one side of the plunger in an orthogonal direction orthogonal to the front-back direction; a second support that supports the plunger to be capable of reciprocating and is disposed on the other side of the plunger; and a support member that supports at least one of the first support and the second support such that the distance between the first support and the second support in the orthogonal direction can be changed.

### TECHNICAL FIELD

The present invention relates to a work machine.

### RELATED ART

Patent Document 1 describes a saber saw (reciprocating saw) as a work machine. In this work machine, a plunger is reciprocated by the drive of a motor, and a blade attached to a tip of the plunger reciprocates and cuts a target object. The plunger is supported by a rotatable roller (bearing) to be capable of reciprocating. The roller is provided above and below the plunger.

### PRIOR-ART DOCUMENTS

### Patent Documents

Patent Document 1: Japanese Utility Model Laid-open No. H5-44414.

### SUMMARY OF THE INVENTION

### Problems to Be Solved by the Invention

In the work machine described in Patent Document 1, depending on the assembly precision of the roller, there is a risk that support performance of the plunger may deteriorate, and workability may be reduced. Specifically, if a distance between shafts of the upper roller and the lower roller is long, the plunger that is reciprocated may rattle; if the distance between shafts is short, it may be difficult for the plunger to move.

In view of the above problem, an object of the present invention is to provide a work machine in which a plunger is appropriately supported, thereby avoiding deterioration of workability.

### Means for Solving the Problems

A work machine according to one embodiment includes: a motor; a plunger, reciprocated in a front-back direction by drive of the motor; a transmission mechanism, converting a rotational driving force of the motor into a reciprocating driving force and transmitting the reciprocating driving force to the plunger; a first support, supporting the plunger to be capable of reciprocating, arranged on one side of the plunger in an orthogonal direction that is orthogonal to the front-back direction; a second support, supporting the plunger to be capable of reciprocating, arranged on the other side of the plunger in the orthogonal direction; and a support member, supporting at least one of the first support and the second support in a manner allowing for changing of a distance between supports being a distance between the first support and the second support in the orthogonal direction.

### Effects of the Invention

In the work machine according to one embodiment, by changing the distance between supports between the first support and the second support by the support member, the plunger is appropriately supported, thus avoiding deterioration of workability.

### BRIEF DESCRIPTION OF THE DRAWINGS

FIG. 1 is a left side view of a work machine according to a first embodiment.

FIG. 2 is a partial cross-sectional left side view of the work machine.

FIG. 3 is an exploded perspective view of a transmission mechanism.

FIG. 4 is a view of the vicinity of a holder as seen from the left side.

FIG. 5 is a cross-sectional view along A-A in FIG. 4.

FIG. 6 is a cross-sectional view along B-B in FIG. 5, in which (A) illustrates a state before a cover is attached, and (B) illustrates a state after the cover is attached.

FIG. 7 is a view showing a holder of a work machine according to a second embodiment.

FIG. 8 is a view showing a holder of a work machine according to a third embodiment.

### DESCRIPTION OF THE EMBODIMENTS

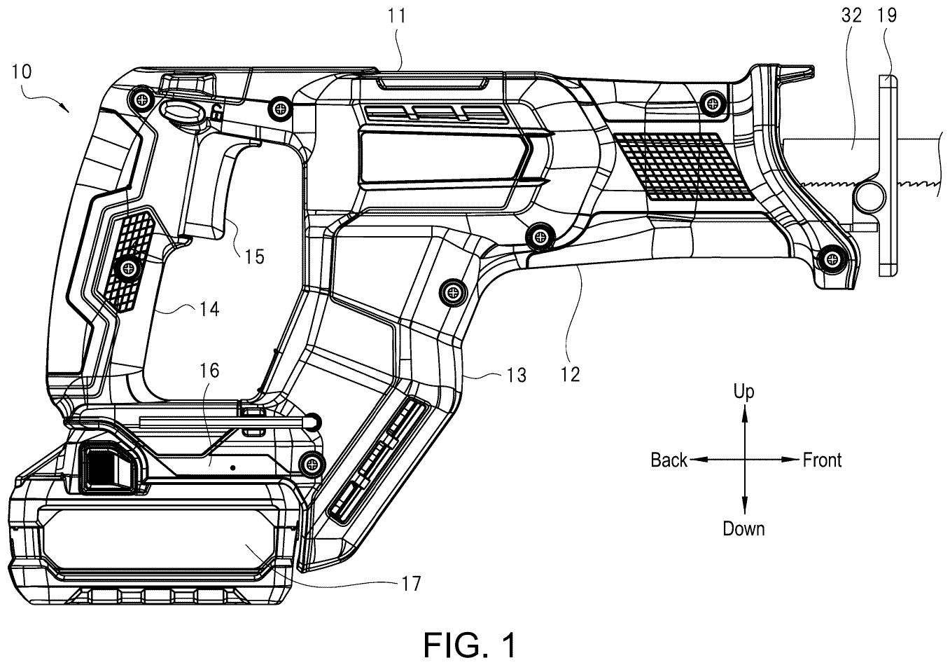

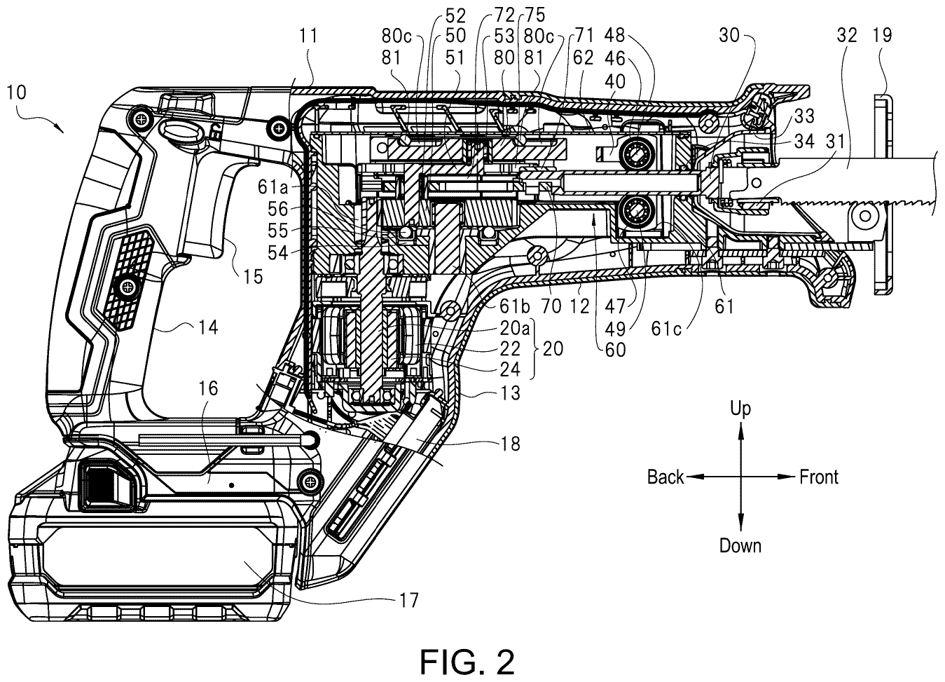

The following describes a work machine according to a first embodiment, a second embodiment, and a third embodiment of the present invention with reference to the drawings. In FIG. 1 and FIG. 2, a front-back direction and an up-down direction are as indicated in the figures. A direction (that is, direction perpendicular to paper surface) orthogonal to the front-back direction and the up-down direction is referred to as a left-right direction.

### First Embodiment

In a work machine 10, as shown in FIG. 2, a plunger 30 is reciprocated in the front-back direction by the drive of a motor 20. The work machine 10 according to the first embodiment is a saber saw (reciprocating saw), in which a blade 32 is attached to the front side of the plunger 30, and the blade 32 reciprocates in the front-back direction and cuts a target object. First, an overview of the work machine 10 will be described with reference to FIG. 1 to FIG. 3.

As shown in FIG. 1, the work machine 10 includes a housing 11 made of metal and synthetic resin. The housing 11 can be divided into two parts in the left-right direction. The housing 11 is provided with a plunger accommodation part 12, a motor accommodation part 13, a handle 14, a trigger 15, a mounting part 16, a base 19, and the like.

The plunger accommodation part 12 is of a tubular shape extending in the front-back direction. The motor accommodation part 13 is of a tubular shape extending downward from a lower portion of the plunger accommodation part 12. The handle 14 is of a shape extending downward from a back portion of the plunger accommodation part 12. The handle 14 is provided with the trigger 15. An operator grips the handle 14 and operates the trigger 15.

The mounting part 16 is provided at a lower portion of the motor accommodation part 13 and the handle 14. The mounting part 16 is mounted with a battery pack 17. The battery pack 17 supplies power to the motor 20. A controller 18 is provided inside the motor accommodation part 13 (see FIG. 2).

When the operator operates the trigger 15, an operation of the trigger 15 is detected by a trigger switch, and a trigger operation signal is transmitted from the trigger switch to the controller 18. The controller 18, upon receiving the trigger operation signal, performs control to actuate the motor 20.

The base 19 is provided in front of the plunger accommodation part 12. The blade 32 penetrates the base 19. The base 19 is movable in the front-back direction with respect to the plunger accommodation part 12 and is tiltable. The base 19 is moved or tilted in accordance with the target object, and a position or angle of the base 19 is adjusted. By performing a cutting operation while the base 19 whose position or angle has been adjusted is pressed against the target object, the blade 32 can be prevented from being damaged.

As shown in FIG. 2, a gear case 60 is provided inside the plunger accommodation part 12. The gear case 60 includes a transmission mechanism accommodation part 61 on the lower side and a cover 62 on the upper side.

The transmission mechanism accommodation part 61 is of a bottomed shape extending in the front-back direction with its upper side open. The transmission mechanism accommodation part 61 is made of metal. A motor shaft hole 61a extending in the up-down direction is formed in a back portion of the transmission mechanism accommodation part 61. A center shaft 61b extending in the up-down direction is provided in a middle portion of the transmission mechanism accommodation part 61. A contact surface 61c extending in the front-back direction is formed in a front portion of the transmission mechanism accommodation part 61.

The cover 62 is of a thin plate-like shape extending in the front-back direction. The cover 62 is made of metal. Accordingly, the cover 62 possesses flexibility. The cover 62 blocks the opening of the transmission mechanism accommodation part 61.

The plunger 30 is accommodated in the gear case 60. The plunger 30 is of a cylindrical shape extending in the front-back direction. The plunger 30 is made of metal. The plunger 30 is supported by a first roller 46 and a second roller 47, and is capable of reciprocating in the front-back direction.

The first roller 46 is an example of a first support. The first support is arranged on one side of the plunger 30 in an orthogonal direction that is orthogonal to the front-back direction. The first roller 46 of the present embodiment is arranged on the upper side of the plunger 30. The first roller 46 is made of resin.

The second roller 47 is an example of a second support. The second support is arranged on the other side of the plunger 30 in the orthogonal direction that is orthogonal to the front-back direction. The second roller 47 of the present embodiment is arranged on the lower side of the plunger 30. The second roller 47 is made of resin.

The first roller 46 is rotatably supported by a first shaft 48. The second roller 47 is rotatably supported by a second shaft 49. The first shaft 48 and the second shaft 49 are made of metal. The first shaft 48 and the second shaft 49 are non-rotatably supported by a holder 40.

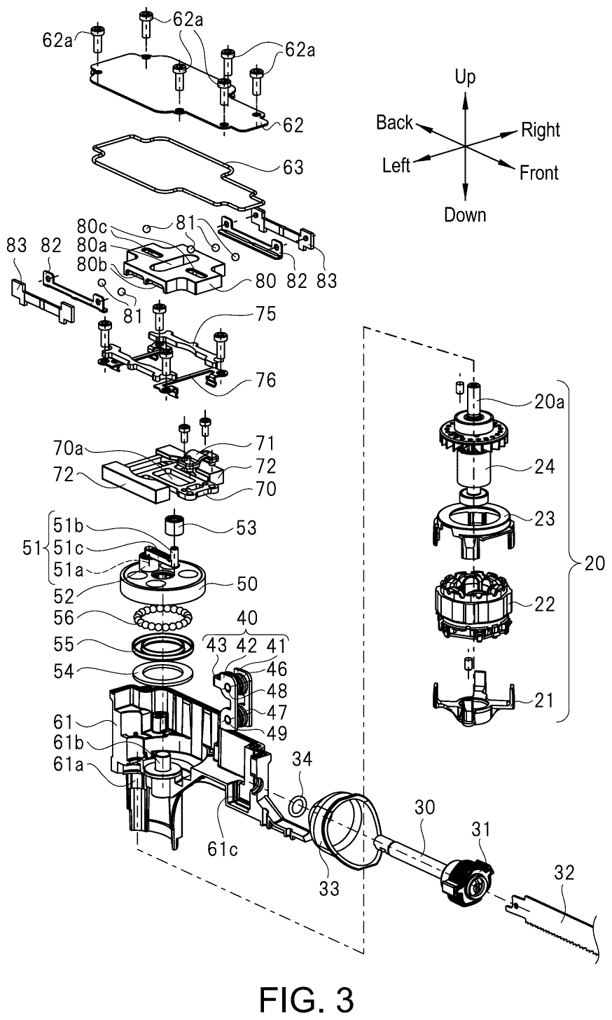

As shown in FIG. 3, the holder 40 includes a right side member 41, a left side member 42, and a connecting member 43 that connects the right side member 41 with the left side member 42. Since the holder 40 is configured as a single member integrating the right side member 41, the left side member 42, and the connecting member 43, manufacturing cost of the holder 40 can be reduced. The holder 40 is made of metal. Back to FIG. 2, a lower surface of the holder 40 is in contact with the contact surface 61c of the transmission mechanism accommodation part 61. An upper surface of the holder 40 is in contact with a lower surface of the cover 62.

A blade holder 31 is provided on the front side of the plunger 30. The blade holder 31 is a tool gripping part. The blade 32 is gripped by the blade holder 31. The blade 32 is an example of a tool, and is a saw blade in the present embodiment. The blade 32 reciprocates in the front-back direction together with the plunger 30 and cuts the target object. A dust guard 33 is provided in front of the gear case 60. An O-ring 34 is provided in a front portion of the gear case 60. By the dust guard 33 and the O-ring 34, chips generated by cutting the target object can be prevented from entering the inside of the gear case 60.

The motor 20 is accommodated in the motor accommodation part 13. The motor 20 includes a stator 22 that does not rotate, a rotor 24 that rotates, a motor shaft 20a that rotates, and the like.

A gear 50 and a connector 70 are accommodated in the gear case 60. The gear 50 is disc-shaped. The gear 50 is made of metal. The gear 50 is axially supported by the center shaft 61b inside the transmission mechanism accommodation part 61. A damper 54 and a thrust washer 55 are arranged between the gear 50 and the transmission mechanism accommodation part 61. A large number of steel balls 56 are rollably arranged inside the thrust washer 55. The steel balls are in contact with a lower surface of the gear 50. The gear 50 is rotatable on the steel balls 56 about the center shaft 61b.

A crankshaft 51 projects on an upper surface of the gear 50. As shown in FIG. 3, the crankshaft 51 includes a first eccentric shaft 51a on one end side, a second eccentric shaft 51b on the other end side, and a connecting rod 51c that connects the first eccentric shaft 51a with the second eccentric shaft 51b. The first eccentric shaft 51a is eccentric from the center shaft 61b. A lower end of the first eccentric shaft 51a is embedded and fixed in the gear 50. The second eccentric shaft 51b is eccentric from the center shaft 61b and the first eccentric shaft 51a. The second eccentric shaft 51b floats above the upper surface of the gear 50.

A needle bearing 52 is attached to the first eccentric shaft 51a. The needle bearing 52 is rotatable with respect to the first eccentric shaft 51a. A sleeve 53 is attached to the second eccentric shaft 51b. The sleeve 53 is rotatable with respect to the second eccentric shaft 51b.

The connector 70 is provided above the gear 50. The connector 70 is made of metal. An elongated hole 70a extending in the front-back direction is formed in the center of the connector 70. The needle bearing 52 is engaged with the elongated hole 70a, and the needle bearing 52 slides within the elongated hole 70a.

A plunger sleeve 71 is attached to a front portion of the connector 70. By the plunger sleeve 71, a back end of the plunger 30 is fixed to the connector 70. Both left and right side surfaces of the connector 70 are supported by a plain bearing 72.

The first eccentric shaft 51a is connected to the plunger 30 via the needle bearing 52 and the connector 70. The connector 70 is capable of reciprocating in the front-back direction together with the plunger 30.

The gear 50, the crankshaft 51, and the connector 70 are examples of a transmission mechanism. The transmission mechanism converts a rotational driving force of the motor 20 into a reciprocating driving force and transmits the reciprocating driving force to the plunger 30. The gear case 60 is an example of a transmission mechanism case. The transmission mechanism case accommodates the transmission mechanism. The transmission mechanism accommodation part 61 is an example of a first case portion. The cover 62 is an example of a second case portion.

A spacer 75 is provided above the connector 70. The spacer 75 is stationary. A counterweight 80 is provided above the spacer 75. The counterweight 80 is driven by the motor 20 to cancel out vibration caused by the reciprocating motion of the plunger 30. The counterweight 80 is made of metal. An elongated hole 80a extending in the left-right direction is formed in the center of the counterweight 80. The sleeve 53 is engaged with the elongated hole 80a, and the sleeve 53 slides within the elongated hole 80a.

A side surface groove 80b is formed on both left and right side surfaces of the counterweight 80. The side surface groove 80b on the left side surface is provided in two places on the front side and the back side. Although not illustrated, the side surface groove 80b on the right side surface is provided in two places on the front side and the back side. A steel ball 81 is inserted into each of a total of four side surface grooves 80b, and the steel ball 81 is rollable within the side surface groove 80b.

An upper surface groove 80c is formed on an upper surface of the counterweight 80. The upper surface groove 80c is provided in two places on the front side and the back side. The steel ball 81 is inserted into each of a total of two upper surface grooves 80c, and the steel ball 81 is rollable within the upper surface groove 80c. The steel ball 81 is an example of a rolling element.

A weight guide 82 and a damper 83 are arranged on both left and right side surfaces of the counterweight 80. The weight guide 82 and the damper 83 are attached to the transmission mechanism accommodation part 61 and are stationary. The weight guide 82 and the damper 83 are examples of a sliding support. The sliding support elastically supports the counterweight 80 in a slidable manner. The damper 83 is an example of an elastic body. The damper 83 of the present embodiment is made of rubber.

The second eccentric shaft 51b is engaged with the counterweight 80 via the sleeve 53. The gear 50, the crankshaft 51, and the connector 70, which are examples of the transmission mechanism, convert the rotational driving force of the motor 20 into the reciprocating driving force of the counterweight 80 and transmit the reciprocating driving force to the counterweight 80.

Referring to FIG. 3, the assembly of each member to a gear case including the transmission mechanism accommodation part 61 and the cover 62 will be described. Each member is sequentially arranged from the bottom of the transmission mechanism accommodation part 61 upward, and is covered with the cover 62, thereby being assembled to the gear case.

First, the motor 20 includes a motor holder 21, the stator 22, a fan guide 23, and the rotor 24. The motor shaft 20a of the motor 20 is inserted into the motor shaft hole 61a provided in the transmission mechanism accommodation part 61.

The damper 54 and the thrust washer 55 are arranged in the transmission mechanism accommodation part 61, and a large number of steel balls 56 are arranged inside the thrust washer 55. The gear 50 is arranged above the steel balls 56. The center shaft 61b provided in the transmission mechanism accommodation part 61 is inserted into the center of the gear 50. The motor shaft 20a comes into contact with a side surface of the gear 50.

The connector 70 to which the plain bearing 72 is attached is arranged above the gear 50. In the crankshaft 51 projecting on the upper surface of the gear 50, the second eccentric shaft 51b and the connecting rod 51c protrude above the connector 70 through the elongated hole 70a formed in the connector 70. In the crankshaft 51, the first eccentric shaft 51a is located inside the elongated hole 70a, and the needle bearing 52 attached to the first eccentric shaft 51a is engaged with the elongated hole 70a.

The first shaft 48 and the second shaft 49 are inserted through the holder 40. The first roller 46 and the second roller 47 are rotatably supported by the first shaft 48 and the second shaft 49. The holder 40 is arranged inside the transmission mechanism accommodation part 61. The lower surface of the holder 40 is brought into contact with the contact surface 61c of the transmission mechanism accommodation part 61.

The plunger 30 is inserted through the dust guard 33 and the O-ring 34, and inserted through the transmission mechanism accommodation part 61. The plunger 30 is inserted between the first roller 46 and the second roller 47. The plunger 30 is fixed to the connector 70 by the plunger sleeve 71.

A metal plate 76 and the spacer 75 are arranged above the connector 70. In the crankshaft 51 projecting on the upper surface of the gear 50, the connecting rod 51c is located at the same height as the spacer 75, and the second eccentric shaft 51b protrudes above the spacer 75.

The left and right weight guides 82 and dampers 83 are arranged above the spacer 75. Two steel balls 81 are arranged above the weight guide 82 on the left, and two steel balls 81 are arranged above the weight guide 82 on the right. The counterweight 80 is arranged between the left and right weight guides 82. Accordingly, a state is achieved in which the four steel balls 81 arranged above the left and right weight guides 82 are inserted into the four side surface grooves 80b formed in the counterweight 80. The sleeve 53 attached to the second eccentric shaft 51b is engaged with the elongated hole 80a. Two steel balls 81 are inserted into the two upper surface grooves 80c formed in the counterweight 80.

By arranging a gasket 63 and the cover 62 above the transmission mechanism accommodation part 61, and screwing the cover 62 to the transmission mechanism accommodation part 61 with a bolt 62a, the gear case 60 is blocked as shown in FIG. 2. The lower surface of the cover 62 comes into contact with the upper surface of the holder 40 and also comes into contact with the steel ball 81 inserted into the upper surface groove 80c.

A reciprocating motion of the plunger 30 and the counterweight 80 driven by the motor 20 will be described. When the motor 20 is rotationally driven, the gear 50 in contact with the motor shaft 20a rotates about the center shaft 61b, and the crankshaft 51 projecting on the gear 50 also rotates about the center shaft 61b.

When the crankshaft 51 rotates, the first eccentric shaft 51a revolves around the center shaft 61b, and the needle bearing 52 attached to the first eccentric shaft 51a also revolves around the center shaft 61b. When the needle bearing 52 revolves, the needle bearing 52 moves while rotating on its own axis within the elongated hole 70a, the connector 70 reciprocates in the front-back direction, and the plunger 30 connected to the connector 70 reciprocates in the front-back direction.

When the crankshaft 51 rotates, the second eccentric shaft 51b also revolves around the center shaft 61b, and the sleeve 53 attached to the second eccentric shaft 51b also revolves around the center shaft 61b. When the sleeve 53 revolves, the sleeve 53 moves while rotating on its own axis within the elongated hole 80a, and the counterweight 80 reciprocates in the front-back direction.

In the present embodiment, the first eccentric shaft 51a and the second eccentric shaft 51b are provided 180° opposite to each other about the center shaft 61b by means of the connecting rod 51c. Thus, when the plunger 30 moves forward, the counterweight 80 moves backward; when the plunger 30 moves backward, the counterweight 80 moves forward. That is, the plunger 30 and the counterweight 80 operate in opposite phases.

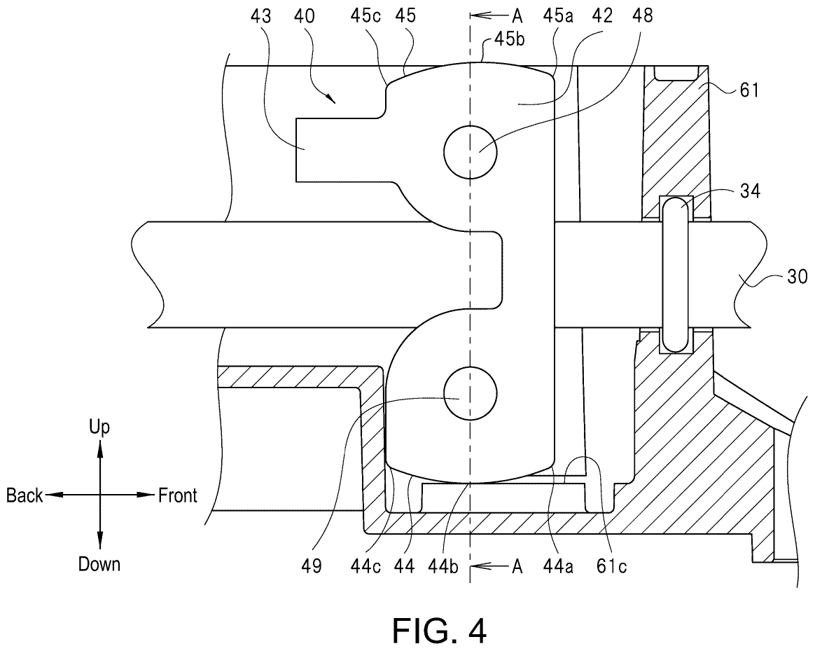

Referring to FIG. 4 to FIG. 6, support of the plunger 30, which is a feature of the present embodiment, will be described. As described above, the plunger 30 is supported by the first roller 46 and the second roller 47. The first roller 46 and the second roller 47 are rotatably supported by the first shaft 48 and the second shaft 49. The first shaft 48 and the second shaft 49 are non-rotatably supported by the holder 40. The holder 40 includes the right side member 41, the left side member 42, and the connecting member 43.

As shown in FIG. 4, a lower curved surface 44 is formed on the lower surface (that is, lower surfaces of right side member 41 and left side member 42) of the holder 40. The lower curved surface 44 is of a shape that descends in a curve from a front end 44a to reach a top 44b, and then ascends in a curve from the top 44b to reach a back end 44c. In a state in which the cover 62 is not attached to the transmission mechanism accommodation part 61 and the holder 40 is standing upright, the top 44b is in contact with the contact surface 61c inside the transmission mechanism accommodation part 61.

An upper curved surface 45 is formed on the upper surface (that is, upper surfaces of right side member 41 and left side member 42) of the holder 40. The upper curved surface 45 is of a shape that ascends in a curve from a front end 45a to reach a top 45b, and then descends in a curve from the top 45b to reach a back end 45c.

In the state in which the cover 62 is not attached to the transmission mechanism accommodation part 61 and the holder 40 is standing upright, the top 45b is exposed from an upper end of the transmission mechanism accommodation part 61. The top 45b is located offset to the front side of center axis lines of the first shaft 48 and the second shaft 49. The top 45b is a pressed part that is pressed (held down) by the lower surface of the cover 62 when the cover 62 is attached thereto.

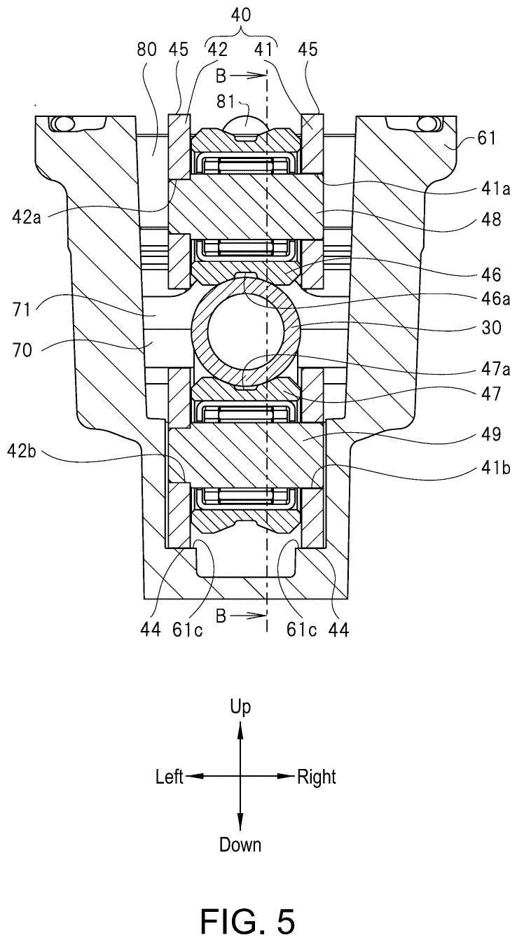

As shown in FIG. 5, an upper through hole 41a and a lower through hole 41b are formed in the right side member 41 of the holder 40. An upper through hole 42a and a lower through hole 42b are formed in the left side member 42 of the holder 40.

In an upper portion of the holder 40, with the first roller 46 arranged between the right side member 41 and the left side member 42, the first shaft 48 is inserted from the right side through the upper through hole 41a, the first roller 46, and the upper through hole 42a. Knurling is performed on an inner peripheral surface of the upper through hole 41a and an outer peripheral surface of the right side of the first shaft 48. By fitting the upper through hole 41a and the first shaft 48 that have undergone knurling, the first shaft 48 is non-rotatably held with respect to the holder 40. The first roller 46 is rotatable about the first shaft 48.

In a lower portion of the holder 40, with the second roller 47 arranged between the right side member 41 and the left side member 42, the second shaft 49 is inserted from the right side through the lower through hole 41b, the second roller 47, and the lower through hole 42b. Knurling is performed on an inner peripheral surface of the lower through hole 41b and an outer peripheral surface of the right side of the second shaft 49. By fitting the lower through hole 41b and the second shaft 49 that have undergone knurling, the second shaft 49 is non-rotatably held with respect to the holder 40. The second roller 47 is rotatable about the second shaft 49.

A recess 46a is formed in the center of an outer peripheral surface of the first roller 46. The first roller 46 is brought into contact with the upper side of the plunger 30 with the outer peripheral surface except for the recess 46a. A recess 47a is formed in the center of an outer peripheral surface of the second roller 47. The second roller 47 is brought into contact with the upper side of the plunger 30 with the outer peripheral surface except for the recess 47a. Since the contact area between the plunger 30 and each of the first roller 46 and the second roller 47 is reduced by formation of the recess 46a and the recess 47a, sliding friction can be reduced.

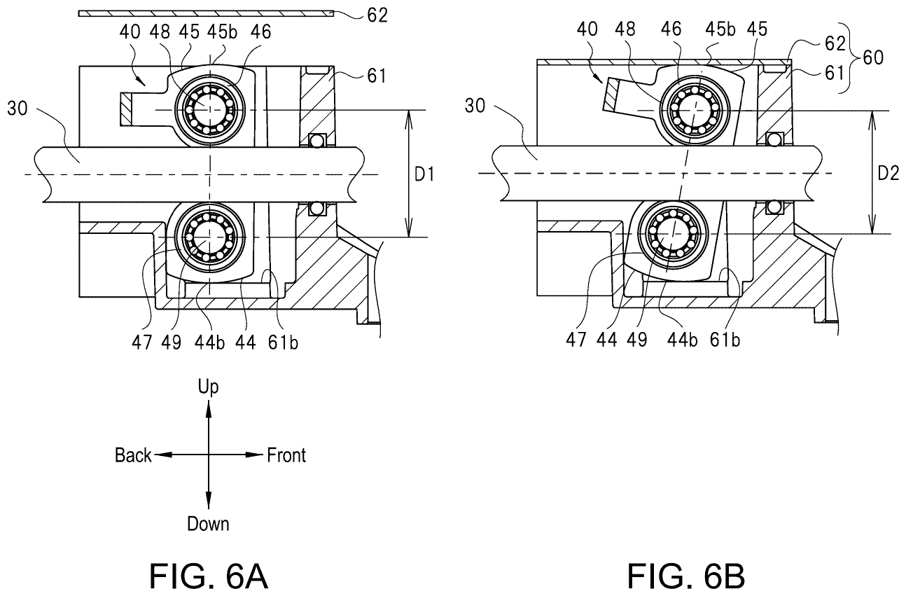

Referring to FIG. 6, tilting of the holder 40 due to the assembly of the gear case 60 will be described. FIG. 6(A) shows a state in which the holder 40 is arranged inside the transmission mechanism accommodation part 61, the plunger 30 is inserted between the first roller 46 and the second roller 47, and the plunger 30 is connected to the connector 70.

In the state before the cover 62 is attached to the transmission mechanism accommodation part 61, the holder 40 is standing upright. In this state, the lower curved surface 44 has the top 44b in contact with the contact surface 61c inside the transmission mechanism accommodation part 61. The upper curved surface 45 has the top 45b exposed (protruding) from the upper end of the transmission mechanism accommodation part 61.

In this state, a distance between supports in the up-down direction between the center axis line of the first shaft 48 and the center axis line of the second shaft 49 is D1. In this state, the holder 40 is indirectly supported (via a support) by the plunger 30, while not being fixed to the gear case 60.

When the cover 62 is attached to the transmission mechanism accommodation part 61 from the state shown in FIG. 6(A), a state shown in FIG. 6(B) is achieved. When the cover 62 is attached to the transmission mechanism accommodation part 61, the top 45b of the holder 40 is pressed by the lower surface of the cover 62. Since the top 45b is located offset to the front side of the center axis lines of the first shaft 48 and the second shaft 49, when the top 45b is pressed, the holder 40 tilts forward. At this time, the top 45b moves forward and is lowered downward. Accordingly, the amount by which the top 45b protrudes from the upper end of the transmission mechanism accommodation part 61 decreases.

After the holder 40 tilts, the cover 62 is fixed to the transmission mechanism accommodation part 61. When the cover 62 is fixed to the transmission mechanism accommodation part 61, the holder 40 becomes immobile in the tilted state. That is, the holder 40 is held by the gear case 60 so that a position where the holder 40 is supported by the gear case 60 does not change. That is, the holder 40 (support) is clamped (in the up-down direction) by the cover 62 and the transmission mechanism accommodation part 61.

In this state, the back side of the upper curved surface 45 relative to the top 45b is in contact with the lower surface of the cover 62. The front side of the lower curved surface 44 relative to the top 44b is in contact with the contact surface 61c inside the transmission mechanism accommodation part 61.

In this state, a distance between supports in the up-down direction between the center axis line of the first shaft 48 and the center axis line of the second shaft 49 is D2. Due to the tilting of the holder 40, D2 is shorter than D1. That is, the holder 40 is held down by the gear case 60 so that the first roller 46 supported by the first shaft 48 and the second roller 47 supported by the second shaft 49 approach each other. According to the position where the holder 40 is supported by the gear case 60, the distance between supports in the up-down direction between the first roller 46 and the second roller 47 is changed.

In this way, since the distance between supports in the up-down direction is reduced, a spacing between the first roller 46 and the second roller 47 is reduced. Thus, the plunger 30 supported by the first roller 46 and the second roller 47 can be prevented from rattling during its reciprocating motion.

Since the cover 62 is a thin plate made of metal and possesses flexibility, the cover 62 elastically biases the holder 40 so that the first roller 46 and the second roller 47 approach the plunger 30. Conversely, when a biasing force (pressing force) of the cover 62 with respect to the holder 40 is excessively strong, since the cover 62 is slightly bent, excessive pressing against the holder 40 is suppressed. Since this flexibility prevents the distance between supports in the up-down direction from becoming unnecessarily short, it will not be difficult for the plunger 30 that reciprocates to move.

The cover 62 is fixed by the bolt 62a. It can be said that the holder 40 is fixed to the gear case 60 by the bolt 62a. That is, the holder 40 is fixed to the gear case 60 by a component that constitutes the gear case 60. If an attachment condition of the cover 62 is changed, the pressing force against the holder 40 is changed, and as a result, the distance between supports is also changed. In this way, the holder 40 (first roller 46 and second roller 47) is supported by the gear case 60 in a manner allowing for changing of the distance between supports. Conventionally, since a first shaft 148 and a second shaft 149 are fixed to the gear case 60, a distance between supports is also fixed. However, in the present invention, since the gear case 60 is supported by a support (first roller 46 and second roller 47) via the holder 40 that is separate from the gear case 60, the distance between supports can be configured to be changeable.

### Second Embodiment

The work machine 10 according to the second embodiment differs from the work machine 10 of the first embodiment only in that a holder 140 is provided instead of the holder 40, while other points remain the same. Thus, this difference will be described. The same configurations as those of the first embodiment are denoted by the same reference numerals, and descriptions thereof are omitted.

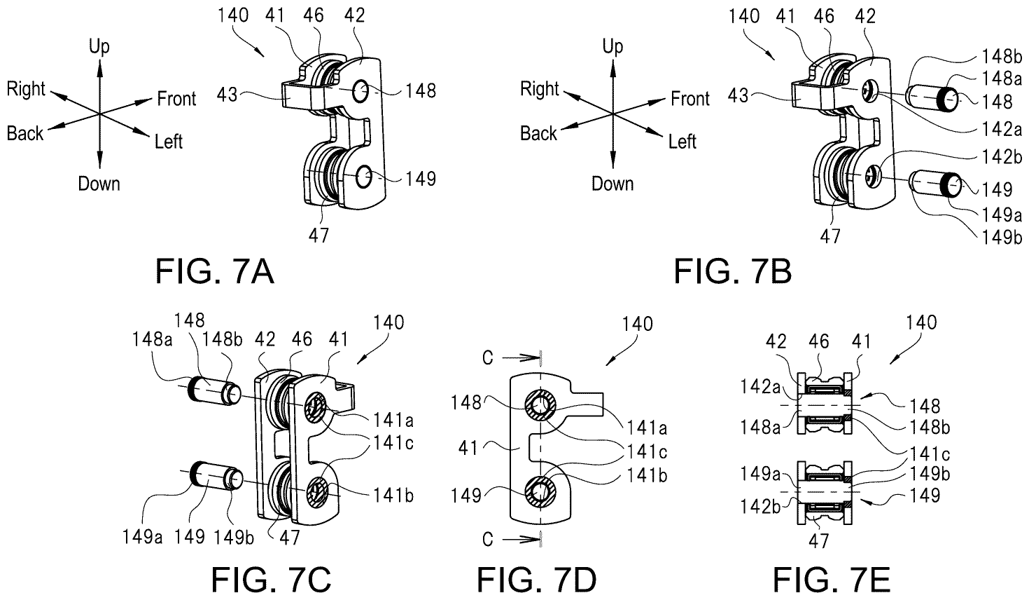

Referring to FIG. 7, the holder 140 will be described. FIG. 7(A) is a perspective view of the holder 140 in an assembled state as seen from the left side. The holder 140 includes the right side member 41, the left side member 42, and the connecting member 43 that connects the right side member 41 with the left side member 42. Since the holder 140 is configured as a single member integrating the right side member 41, the left side member 42, and the connecting member 43, manufacturing cost of the holder 140 can be reduced. The holder 140 is made of metal.

A first shaft 148 and a second shaft 149 are inserted through the holder 140. The first roller 46 and the second roller 47 are rotatably supported by the first shaft 148 and the second shaft 149

FIG. 7(B) is a perspective view of the holder 140 as seen from the left side before the first shaft 148 and the second shaft 149 are inserted. An upper through hole 142a and a lower through hole 142b are formed in the left side member 42.

Knurling is performed on an inner peripheral surface of the upper through hole 142a and an outer peripheral surface of a left end 148a of the first shaft 148. By fitting the upper through hole 142a and the first shaft 148, both of which have undergone knurling, the first shaft 148 is non-rotatably held with respect to the holder 140.

Knurling is also performed on an inner peripheral surface of the lower through hole 142b and an outer peripheral surface of the left side of the second shaft 149. By fitting the lower through hole 142b and the second shaft 149, both of which have undergone knurling, the second shaft 149 is non-rotatably held with respect to the holder 140.

FIG. 7(C) is a perspective view of the holder 140 as seen from the right side before the first shaft 148 and the second shaft 149 are inserted. An upper through hole 141a and a lower through hole 141b are formed in the right side member 41.

An elastic ring 141c of an annular shape is fitted to an inner peripheral surface of the upper through hole 141a. A step portion is formed on an outer peripheral surface of a right end 148b of the first shaft 148. The elastic ring 141c of an annular shape is also fitted to an inner peripheral surface of the lower through hole 141b. A step portion is formed on an outer peripheral surface of a right end 149b of the second shaft 149. In the present embodiment, the elastic ring 141c is made of rubber.

FIG. 7(D) is a right side view of the holder 140 in the assembled state, and FIG. 7(E) is a cross-sectional view along C-C in FIG. 7(D). In an upper portion of the holder 140, with the first roller 46 arranged between the left side member 42 and the right side member 41, the first shaft 148 is inserted from the left side through the upper through hole 142a, the first roller 46, and the upper through hole 141a. The left end 148a of the first shaft 148 is non-rotatably held in the upper through hole 142a, and the right end 148b of the first shaft 148 is elastically supported by the elastic ring 141c.

In a lower portion of the holder 140, with the second roller 47 arranged between the left side member 42 and the right side member 41, the second shaft 149 is inserted from the left side through the lower through hole 142b, the second roller 47, and the lower through hole 141b. A left end 149a of the second shaft 149 is non-rotatably held in the lower through hole 142b, and the right end 149b of the second shaft 149 is elastically supported by the elastic ring 141c.

By the elastic rings 141c, the plunger 30 is elastically supported via the first shaft 148 and the second shaft 149 as well as the first roller 46 and the second roller 47. Thus, the plunger 30 can be smoothly reciprocated. In the case where a pressing force from the cover 62 is excessively large, the elastic ring 141c can be compressed, and excessive contact between the plunger 30 and the support (first roller 46 and second roller 47) can be suppressed.

In the second embodiment, the distance between supports may be configured to be slightly smaller than an outer diameter of the plunger 30, so that, when the plunger 30 is inserted between the first roller 46 and the second roller 47, the elastic ring 141c is compressed and the distance between supports increases. In this case, the holder 140 may be configured to be fixed to the transmission mechanism accommodation part 61 by a screw or the like. That is, in this case, the configuration of the first embodiment that the holder 40 tilts due to the pressing from the cover 62 may not be necessary.

### Third Embodiment

The work machine 10 according to the third embodiment differs from the work machine 10 of the second embodiment only in that a holder 240 is provided instead of the holder 140, while other points remain the same. Thus, this difference will be described. The same configurations as those of the first embodiment and the second embodiment are denoted by the same reference numerals, and descriptions thereof are omitted.

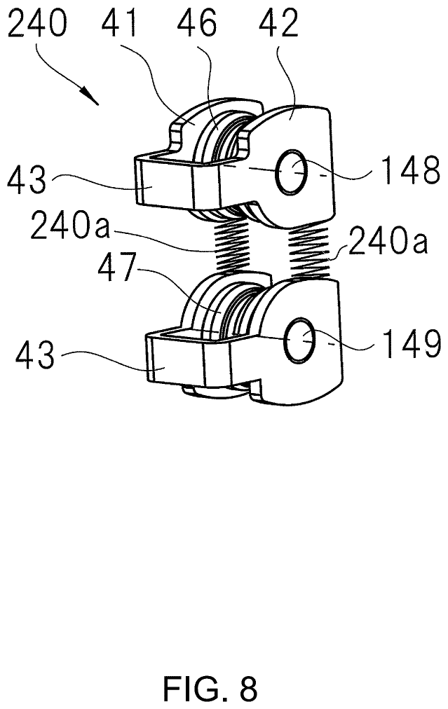

Referring to FIG. 8, the holder 240 will be described. The holder 240 is configured so that an upper portion holding the first shaft 148 and a lower portion holding the second shaft 149 are separated in the up-down direction, and a coil spring 240a connects between them. That is, the holder 240 includes the coil spring 240a at a center position in the up-down direction. The coil spring 240a is provided one each on both the left and right sides. The holder 240 may be composed of one large coil spring.

In the holder 240 with no external force applied thereto, the distance between supports (spacing in the up-down direction) between a first support (first roller 46) and a second support (second roller 47) is smaller than the outer diameter of the plunger 30. When the plunger 30 is inserted into the holder 240 (first roller 46 and second roller 47), the coil spring 240a extends, the distance between supports increases, and the first roller 46 and the second roller 47 contact the top and bottom of the plunger 30, respectively. In this state, by sandwiching and holding the holder 240 in the up-down direction by the transmission mechanism accommodation part 61 (contact surface 61c) and the cover 62, the holder 240 is fixed to the gear case 60.

In the state in which the plunger 30 is inserted into the holder 240 (first roller 46 and second roller 47) and the distance between supports has increased, the holder 240 may be fixed to the gear case 60 using a fastener such as a screw or the like.

With this method, the support (first roller 46 and second roller 47) adjusted to an optimal distance can be fixed to the gear case 60 without using the cover 62 for clamping. Before an external force is applied, the distance between supports may be configured to be larger than the outer diameter of the plunger 30, and the coil spring 240a compresses due to the pressing from above by the cover 62, so that the distance between supports decreases.

The third embodiment is similar to the first embodiment in that the distance between supports decreases due to the attachment (pressing) of the cover 62. However, the first embodiment is characterized in that the holder 40 tilts and the distance between supports is decreased; hence, space in the front-back direction has to be secured. On the other hand, in the third embodiment, such space securing becomes unnecessary. Compared to the first embodiment where the holder 40 is configured as a single member, in the case of using the holder 240, the number of parts increases by two.

### Modifications

The present invention is not limited to the above embodiments but can be modified in various ways without departing from the gist thereof.

In the above embodiments, an example has been described in which the holder 40 (or holder 140) as a support member supports both a first support (first roller 46) and a second support (second roller 47). The support member may support at least one of the first support and the second support in a manner allowing for changing of the distance between supports between the first support and the second support. For example, both or one of the first support and the second support may be elastically supported on the gear case 60 by an elastic body such as a spring, and may be configured to be biased toward a plunger so that the distance between supports decreases. The first support may be fixed to the gear case 60, and the second support may be elastically supported on the gear case 60 by a spring or the like.

In the above embodiments, the distance between supports between the first support and the second support is configured to be changed by directly or indirectly applying an external force to the support (holder) by the cover 62 or the plunger 30 that is separate from the transmission mechanism accommodation part 61 that supports the holder. However, a member other than the cover 62 or the plunger 30, which is separate from the transmission mechanism accommodation part 61, may be used.

In the above embodiments, the holder is configured to be clamped by the divided pieces of the gear case 60 divided in the up-down direction. However, the holder may be configured to be clamped by a gear case that is divided in the left-right direction.

In the above embodiments, an example has been described in which the support that supports the plunger 30 to be capable of reciprocating is a roller (first roller 46 and second roller 47). However, the support may be something other than a roller. For example, the support may be a plain bearing. In this case, both the lower and upper plain bearings may be elastically supported on the gear case 60, or one plain bearing may be fixed to the gear case 60 and the other plain bearing may be elastically supported on the gear case 60. The plain bearing may not be directly supported on the gear case 60, and may be supported on the holder.

In the above embodiments, an example has been described in which the holder 40 tilts forward to achieve an inclined state, as shown in FIG. 6(B). However, the holder 40 may tilt backward to achieve the inclined state. In this case, the top 45b of the upper curved surface 45 is provided offset to the back side of the center axis of the first shaft 48.

### DESCRIPTION OF REFERENCE NUMERALS

10: work machine; 20: motor; 30: plunger; 40: holder; 46: first roller; 47: second roller; 48: first shaft; 49: second shaft; 50: gear; 51: crankshaft; 51a: first eccentric shaft; 51b: second eccentric shaft; 51c: connecting rod; 52: needle bearing; 53: sleeve; 60: gear case; 61: transmission mechanism accommodation part; 62: cover; 70: connector; 70a: elongated hole; 80: counterweight; 80a: elongated hole

1. A work machine, comprising:
a motor;
a plunger, reciprocated in a front-back direction by drive of the motor;
a transmission mechanism, converting a rotational driving force of the motor into a reciprocating driving force and transmitting the reciprocating driving force to the plunger;
a first support, supporting the plunger to be capable of reciprocating, arranged on one side of the plunger in an orthogonal direction that is orthogonal to the front-back direction;
a second support, supporting the plunger to be capable of reciprocating, arranged on an other side of the plunger in the orthogonal direction; and
a support member, supporting at least one of the first support and the second support in a manner allowing for changing of a distance between supports being a distance between the first support and the second support in the orthogonal direction.

2. The work machine according to claim 1, comprising:
a transmission mechanism case, accommodating the transmission mechanism, wherein
the transmission mechanism case is able to be divided into a transmission mechanism accommodation part and a cover, and
the first support and the second support are supported by the transmission mechanism accommodation part in a manner allowing for changing of the distance between supports.

3. A work machine, comprising:
a motor;
a plunger, reciprocated in a front-back direction by drive of the motor;
a transmission mechanism, converting a rotational driving force of the motor into a reciprocating driving force and transmitting the reciprocating driving force to the plunger;
a transmission mechanism case, accommodating the transmission mechanism;
a first support, supporting the plunger to be capable of reciprocating, arranged on one side of the plunger in an orthogonal direction that is orthogonal to the front-back direction;
a second support, supporting the plunger to be capable of reciprocating, arranged on an other side of the plunger in the orthogonal direction; and
a holder, supporting the first support and the second support, held down by the transmission mechanism case so that the first support and the second support approach each other in the orthogonal direction.

4. The work machine according to claim 1, wherein at least one of the first support and the second support is elastically biased to approach the plunger.

5. The work machine according to claim 3, wherein
the first support comprises a first roller arranged on one side of the plunger in the orthogonal direction, and a first shaft rotatably supporting the first roller;
the second support comprises a second roller arranged on the other side of the plunger in the orthogonal direction, and a second shaft rotatably supporting the second roller; and
the holder supports the first shaft and the second shaft, and is held down by the transmission mechanism case so that the first roller and the second roller approach the plunger in the orthogonal direction.

6. The work machine according to claim 5, wherein
the holder is supported by the transmission mechanism case so that a line connecting a center axis of the first shaft and a center axis of the second shaft is inclined with respect to the front-back direction.

7. The work machine according to claim 6, wherein
the transmission mechanism case comprises a first case portion contacting one side of the holder in the orthogonal direction, and a second case portion contacting an other side of the holder in the orthogonal direction;
the one side of the holder in the orthogonal direction is provided with a curved surface that is curved from one end side to an other end side in the front-back direction; and
the other side of the holder in the orthogonal direction is provided with a pressed part that is offset in the front-back direction relative to the first shaft and the second shaft and is pressed by the second case portion.

8. The work machine according to claim 5, wherein
the holder is configured as a single member.

9. The work machine according to claim 5, wherein
a distance between the first roller and the second roller in the orthogonal direction is changed according to a position where the holder is supported by the transmission mechanism case.

10. The work machine according to claim 5, wherein
the holder is held by the transmission mechanism case so that a position where the holder is supported by the transmission mechanism case does not change.

11. The work machine according to claim 5, wherein
the first roller and the second roller are elastically biased to approach the plunger.

12. The work machine according to claim 1, comprising:
a transmission mechanism case, comprising a transmission mechanism accommodation part that accommodates the transmission mechanism, and a cover that is attached to the transmission mechanism accommodation part, wherein
the distance between supports is changed by supporting, by the transmission mechanism accommodation part, a member configured as a separate member from the transmission mechanism accommodation part.

13. The work machine according to claim 12, wherein
the distance between supports is changed by at least one of the first support and the second support being biased from the cover or the plunger.

14. The work machine according to claim 13, wherein
at least one of the first support and the second support is biased by the cover to decrease the distance between supports, or the distance between supports is increased by the plunger entering between the first support and the second support.

15. A work machine, comprising:
a motor;
a plunger, reciprocated in a front-back direction by drive of the motor;
a transmission mechanism, converting a rotational driving force of the motor into a reciprocating driving force and transmitting the reciprocating driving force to the plunger;
a transmission mechanism case, comprising a transmission mechanism accommodation part that accommodates the transmission mechanism, and a cover that is attached to the transmission mechanism accommodation part;
a first support, supporting the plunger to be capable of reciprocating, arranged on one side of the plunger in an orthogonal direction that is orthogonal to the front-back direction;
a second support, supporting the plunger to be capable of reciprocating, arranged on an other side of the plunger in the orthogonal direction; and
a support member, supporting at least one of the first support and the second support in a manner allowing for changing of a distance between supports being a distance between the first support and the second support in the orthogonal direction, wherein
the support member is clamped by the transmission mechanism accommodation part and the cover.

16. The work machine according to claim 3, wherein
at least one of the first support and the second support is elastically biased to approach the plunger.
